(19) United States
(12) Patent Application Publication
(10) Pub. No.: US 2025/0077784 A1
(43) Pub. Date: Mar. 6, 2025

(54) METHODS AND SYSTEMS FOR FACILITATING GUIDING CONVERSATION WITH AT LEAST ONE LARGE LEARNING MODEL

(71) Applicant: Corey Dayhuff, Westerville, OH (US)

(72) Inventor: Corey Dayhuff, Westerville, OH (US)

(21) Appl. No.: 18/509,054

(22) Filed: Nov. 14, 2023

Related U.S. Application Data
(60) Provisional application No. 63/579,442, filed on Aug. 29, 2023.

(51) Int. Cl. G06F 40/35

(52) U.S. Cl. CPC G06F 40/35

(57) ABSTRACT

Disclosed herein is a method for facilitating guiding conversation with at least one large language model. Accordingly, the method may include receiving, using a communication device, a request from at least one user device associated with at least one user, transmitting, using the communication device, the request to at least one server, and receiving, using the communication device, a response corresponding to the request from the at least one server. Further, the method may include retrieving, using a storage device, at least one guideline based on the receiving of the response. Further, the method may include validating, using a processing device, the response based on the at least one guideline and generating, using the processing device, a validation indicator associated with the response based on the validating. The method may include transmitting, using the communication device, the response to the at least one user device based on the validation indicator.

### FIELD OF THE INVENTION

Generally, the present disclosure relates to the field of data processing. More specifically, the present disclosure relates to methods and systems for facilitating guiding conversation with at least one large learning model.

### BACKGROUND OF THE INVENTION

The field of data processing is technologically important to several industries, business organizations, and/or individuals.

Existing techniques for guiding conversation of large language models (LLMs) are deficient with regard to several aspects. LLMs can generate information (or response) without filtering which can include banned keywords. Further, current technologies do not verify the responses generated by artificial intelligence models such as LLMs. Furthermore, current technologies do not verify the intent of the responses generated by the LLMs which can sometimes provide wrong information.

Therefore, there is a need for improved methods and systems for facilitating guiding conversation with at least one large learning model that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating guiding conversation with at least one large language model, in accordance with some embodiments. Accordingly, the method may include receiving, using a communication device, a request from at least one user device associated with at least one user. Further, the method may include transmitting, using the communication device, the request to at least one server. Further, the server may be configured for hosting the at least one large language model. Further, the method may include receiving, using the communication device, a response corresponding to the request from the at least one server. Further, the method may include retrieving, using a storage device, at least one guideline based on the receiving of the response. Further, the method may include validating, using a processing device, the response based on the at least one guideline. Further, the method may include generating, using the processing device, a validation indicator associated with the response based on the validating. Further, the method may include transmitting, using the communication device, the response to the at least one user device based on the validation indicator.

Further disclosed herein is a system for facilitating guiding conversation with at least one large language model, in accordance with some embodiments. Accordingly, the system may include a communication device configured for receiving a request from at least one user device associated with at least one user. Further, the communication device may be configured for transmitting the request to at least one server. Further, the server may be configured for hosting the at least one large language model. Further, the communication device may be configured for receiving a response corresponding to the request from the at least one server. Further, the communication device may be configured for transmitting the response to the at least one user device based on a validation indicator. Further, the system may include a processing device communicatively coupled with the communication device. Further, the processing device may be configured for validating the response based on at least one guideline. Further, the processing device may be configured for generating the validation indicator associated with the response based on the validating. Further, the system may include a storage device communicatively coupled with the processing device. Further, the storage device may be configured for retrieving the at least one guideline based on the receiving of the response.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow chart of a method 200 for facilitating guiding conversation with at least one large language model, in accordance with some embodiments.

FIG. 3 is a flow chart of a method 300 for guiding conversation with at least one large language model, in accordance with some embodiments.

FIG. 4 is a flow chart of a method 400 for guiding conversation with at least one large language model, in accordance with some embodiments.

FIG. 5 is a flow chart of a method 500 for guiding conversation with at least one large language model, in accordance with some embodiments.

FIG. 6 is a flow chart of a method 600 for guiding conversation with at least one large language model, in accordance with some embodiments.

FIG. 7 is a flow chart of a method 700 for guiding conversation with at least one large language model, in accordance with some embodiments.

FIG. 8 is a flow chart of a method 800 for guiding conversation with at least one large language model, in accordance with some embodiments.

FIG. 9 is a flow chart of a method 900 for guiding conversation with at least one large language model, in accordance with some embodiments.

FIG. 10 is a block diagram of a system 1000 for facilitating guiding conversation with at least one large language model, in accordance with some embodiments.

FIG. 11 is a block diagram of the system 1000 for facilitating guiding conversation with at least one large language model, in accordance with some embodiments.

FIG. 12 is a flow chart of a method 1200 for facilitating guiding conversation with artificial intelligence models, in accordance with some embodiments.

FIG. 13 is a schematic of a system 1300 for facilitating guiding conversation with artificial intelligence models, in accordance with some embodiments.

FIG. 14 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating guiding conversation with at least one large learning model, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, physical state and/or physiological state and/or psychological state of the user, corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating guiding conversation with at least one large learning model. Further, GuidedAI, an exemplary embodiment of the disclosed system herein allows a user (such as a company/person) to control/guide the conversation with multiple large language models. Further, the disclosed system may be configured for giving guide rails to corporate usage of large language models, allowing them to control the message, but leverage the capabilities of any API-enabled large language model like ChatGPT. In total, the solution provided by the disclosed system sits on top of all large language models allowing controlled access to the capabilities of any LLM.

Further, the disclosed system may provide a gateway to large language models that allow an administration function to guide how questions/statements are presented to the large language model. After an answer is retrieved from the large language model, an administration function associated with the disclosed system allows the system to validate that the response falls within the guidelines.

Further, the disclosed system may be associated with a SAAS-based software offering that leverages HTML, javascript, and a database. Further, the disclosed system may be configured for receiving requests to the gateway which are received with qualifier instructions from a chat interface. Further, the disclosed system may look up instructions from the administration database to add to the request that is sent to the large language model. The response from the large language model is validated upon return to ensure the intent and language do not violate the guidelines defined. Further, the administration function is called from a chat service. The administration function calls an administration database and then calls the LLM. Upon response, the disclosed system may use the administration function to read a response, call the administration database, and validate no keywords are used that are blocked and reads the response for the intent and if verified passes it back to the chatbot. The administration function allows a user or admin to create the controls around the conversation with the LLMs.

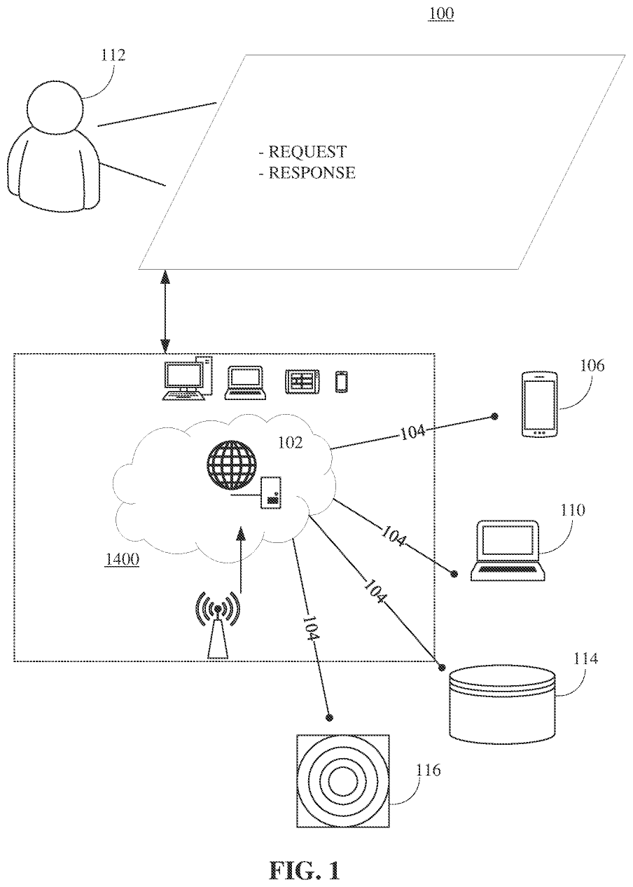

FIG. 1 is an illustration of an online platform 100 consistent with various embodiments of the present disclosure. By way of non-limiting example, the online platform 100 for facilitating guiding conversation with at least one large learning model may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1400.

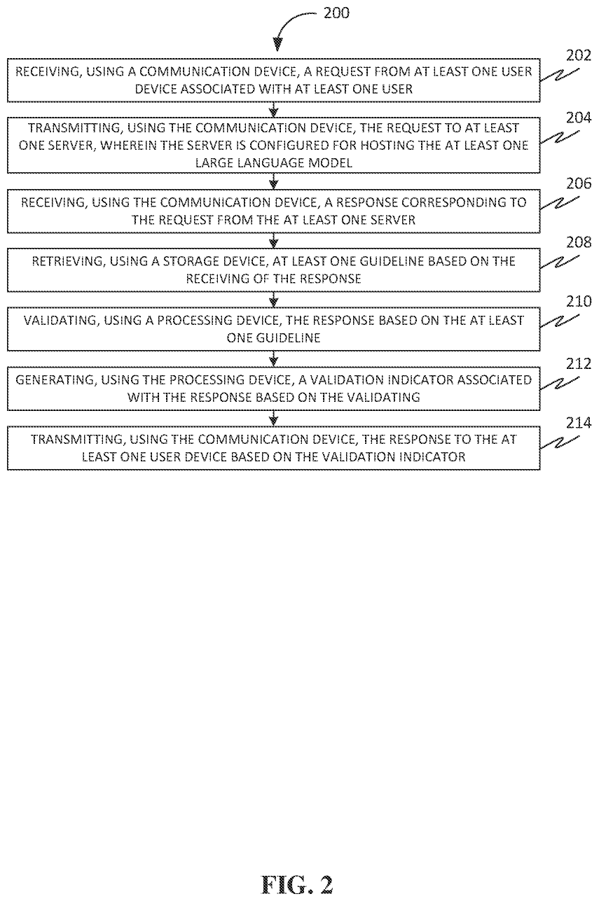

FIG. 2 is a flow chart of a method 200 for facilitating guiding conversation with at least one large language model, in accordance with some embodiments. Accordingly, at 202, the method 200 may include receiving, using a communication device (such as a communication device 1002), a request from at least one user device (such as at least one user device 1102) associated with at least one user. Further, at 204, the method 200 may include transmitting, using the communication device, the request to at least one server (such as at least one server 1104). Further, the at least one server may be configured for hosting the at least one large language model. Further, at 206, the method 200 may include receiving, using the communication device, a response corresponding to the request from the at least one server. Further, at 208, the method 200 may include retrieving, using a storage device (such as a storage device 1006), at least one guideline based on the receiving of the response. Further, at 210, the method 200 may include validating, using a processing device (such as a processing device 1004), the response based on the at least one guideline. Further, at 212, the method 200 may include generating, using the processing device, a validation indicator associated with the response based on the validating. Further, the validation indicator may indicate if the response complies with the at least one guideline. Further, in an instance, the at least one guideline may include a prohibition of usage of blocked keywords. Further, in another instance, the at least one guideline may include a prohibition of access to certain content (such as websites, images, documents, etc.). Further, at 214, the method 200 may include transmitting, using the communication device, the response to the at least one user device based on the validation indicator. Accordingly, the at least one large language model may include ChatGPT, Google™ Bert, etc. Further, the at least one guideline may be associated with operations of a business/corporation run by an administrator. Further, the at least one user may include an employee working for the business. Further, the at least one user device may include a smartphone, a tablet, a laptop, a mobile, a client device, etc. Further, the validation indicator may include a rating, a score, etc.

Further, in some embodiments, the method 200 may include receiving, using the communication device, at least one business information from at least one administrator device associated with at least one administrator. Further, the at least one business information describes operations of a business run by the at least one administrator. Further, the method 200 may include analyzing, using the processing device, the at least one business information. Further, the method 200 may include generating, using the processing device, the at least one guideline based on the analyzing of the at least one business information. Further, the method 200 may include storing, using the storage device, the at least one guideline.

Further, in some embodiments, the method 200 may include obtaining, using the processing device, at least one factual information corresponding to the request. Further, the method 200 may include analyzing, using the processing device, the at least one factual information and the response. Further, the method 200 may include determining, using the processing device, a response accuracy corresponding to the response based on the analyzing of the at least one factual information and the response. Further, the generating of the validation indicator may be based on the determining of the response accuracy.

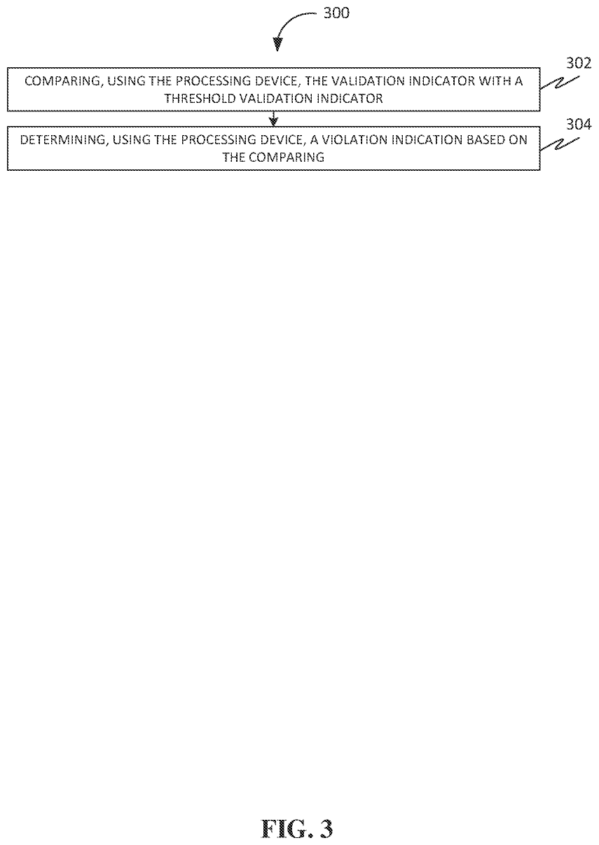

FIG. 3 is a flow chart of a method 300 for guiding conversation with at least one large language model, in accordance with some embodiments. Accordingly, at 302, the method 300 may include comparing, using the processing device, the validation indicator with a threshold validation indicator. Further, at 304, the method 300 may include determining, using the processing device, a violation indication based on the comparing. Further, the violation indication may include one of a positive violation indication indicating violation of the response according to the at least one guideline and a negative violation indication indicating compliance of the response to the at least one guideline. Further, the transmitting of the response to the at least one user device may be based on the violation indication. Further, the threshold validation indicator may include a minimum rating for the validation indicator below which the response received from the at least one server may be violating the at least one guideline.

Further, in some embodiments, the validating may include analyzing the response using a machine learning model. Further, the validating may include determining an intent associated with the response based on the analyzing of the response. Further, the validating may include analyzing the intent based on the at least one guideline. Further, the validating may include determining an intent compliance indication associated with the intent based on the analyzing of the intent. Further, the machine learning model may include a natural language processing model trained for identifying an intent of the response.

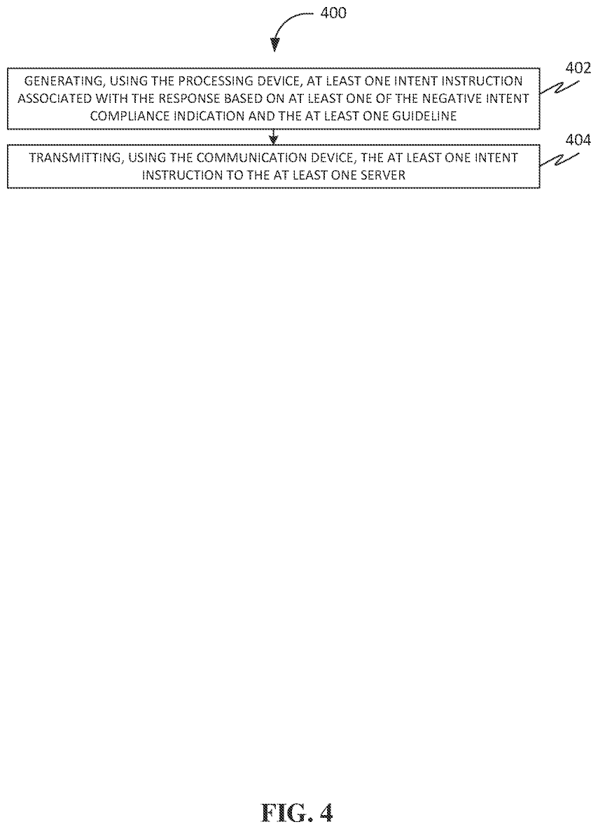

FIG. 4 is a flow chart of a method 400 for guiding conversation with at least one large language model, in accordance with some embodiments. Accordingly, the intent compliance indication may include a negative intent compliance indication. Further, the negative intent compliance indication represents a violation of the at least one guideline by the response. Further, at 402, the method 400 may include generating, using the processing device, at least one intent instruction associated with the response based on at least one of the negative intent compliance indication and the at least one guideline. Further, at 404, the method 400 may include transmitting, using the communication device, the at least one intent instruction to the at least one server. Further, the at least one large language model generates the response based on the at least one intent instruction and the request to avoid violation of the at least one guideline.

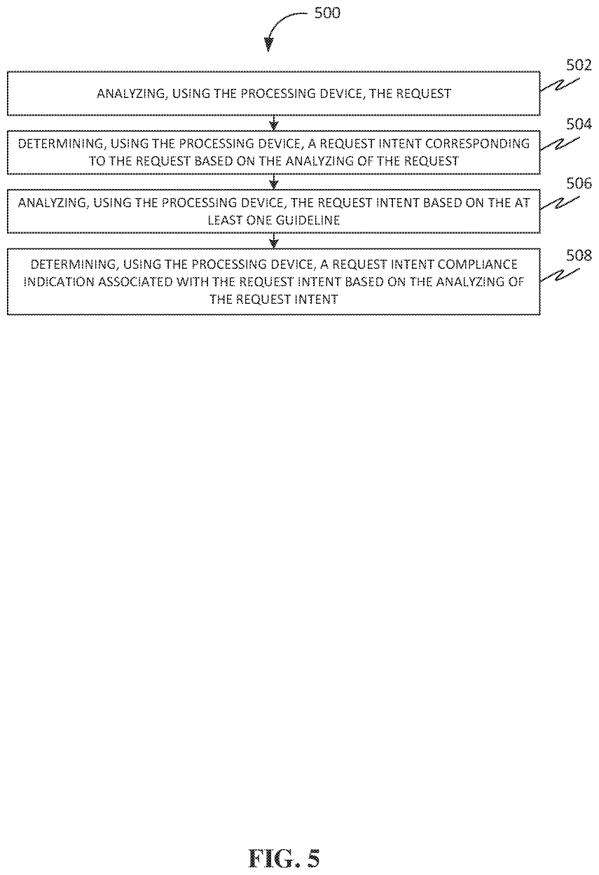

FIG. 5 is a flow chart of a method 500 for guiding conversation with at least one large language model, in accordance with some embodiments. Accordingly, at 502, the method 500 may include analyzing, using the processing device, the request. Further, at 504, the method 500 may include determining, using the processing device, a request intent corresponding to the request based on the analyzing of the request. Further, at 506, the method 500 may include analyzing, using the processing device, the request intent based on the at least one guideline. Further, at 508, the method 500 may include determining, using the processing device, a request intent compliance indication associated with the request intent based on the analyzing of the request intent. Further, the transmitting of the request may be based on the request intent compliance indication.

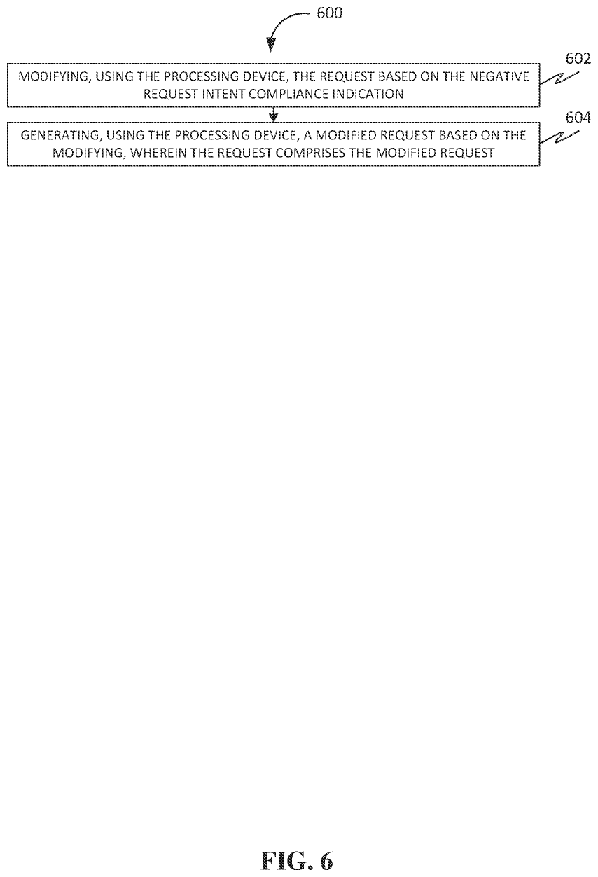

FIG. 6 is a flow chart of a method 600 for guiding conversation with at least one large language model, in accordance with some embodiments. Accordingly, the request intent compliance indication may include a negative request intent compliance indication. Further, the negative request intent compliance indication represents a violation of the at least one guideline by the request. Further, at 602, the method 600 may include modifying, using the processing device, the request based on at least one of the negative request intent compliance indication and the at least one guideline. Further, at 604, the method 600 may include generating, using the processing device, a modified request based on the modifying. Further, the request may include the modified request.

Further, in some embodiments, the validating may include analyzing the response using a second machine learning model. Further, the validating may include determining a language compliance indication corresponding to the response based on the analyzing of the response. Further, the language compliance indication represents that the response comprises at least one permitted keyword.

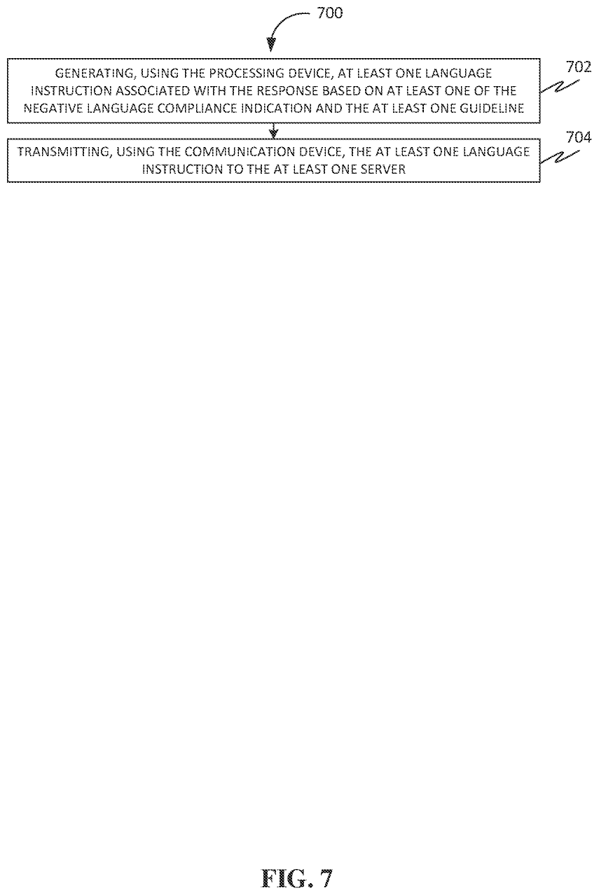

FIG. 7 is a flow chart of a method 700 for guiding conversation with at least one large language model, in accordance with some embodiments. Accordingly, the language compliance indication may include a negative language compliance indication representing usage of at least one blocked keyword in the response. Further, at 702, the method 700 may include generating, using the processing device, at least one language instruction associated with the response based on at least one of the negative language compliance indication and the at least one guideline. Further, the at least one language instruction may include an additional information associated with the request to avoid usage of the at least one blocked keyword in the response. Further, in an instance, the additional information may include alternate words for replacing the at least one blocked keyword. Further, at 704, the method 700 may include transmitting, using the communication device, the at least one language instruction to the at least one server. Further, the at least one large language model generates the response based on the at least one language instruction and the request to avoid usage of the at least one blocked keyword in the response.

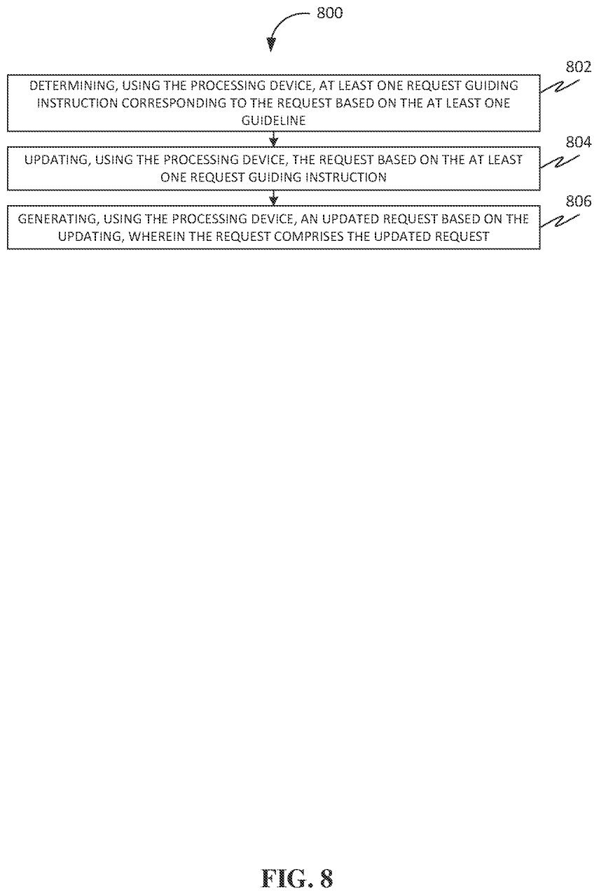

FIG. 8 is a flow chart of a method 800 for guiding conversation with at least one large language model, in accordance with some embodiments. Accordingly, at 802, the method 800 may include determining, using the processing device, at least one request guiding instruction corresponding to the request based on the at least one guideline. Further, at 804, the method 800 may include updating, using the processing device, the request based on the at least one request guiding instruction. Further, at 806, the method 800 may include generating, using the processing device, an updated request based on the updating. Further, the request may include the updated request.

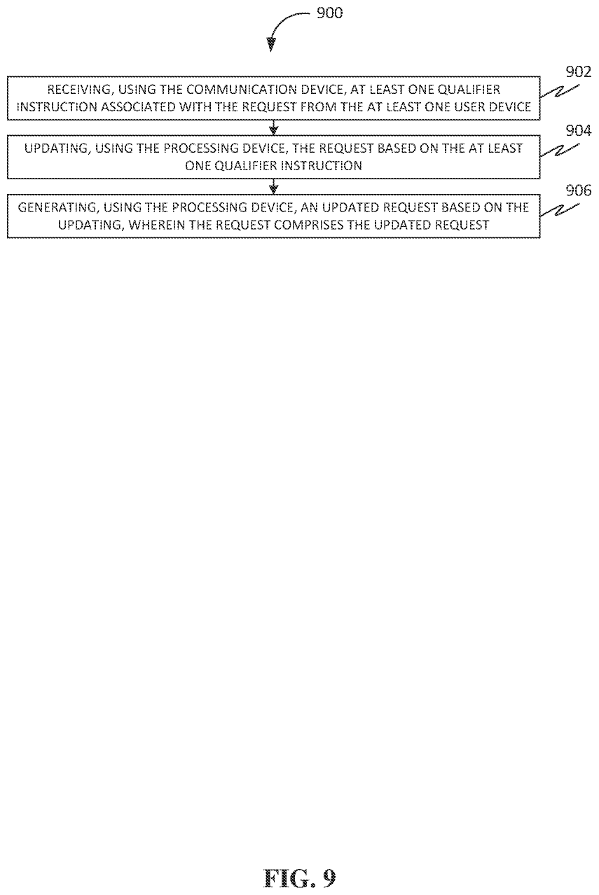

FIG. 9 is a flow chart of a method 900 for guiding conversation with at least one large language model, in accordance with some embodiments. Accordingly, at 902, the method 900 may include receiving, using the communication device, at least one qualifier instruction associated with the request from the at least one user device. Further, the at least one qualifier instruction may include additional information to receive the response that may be more accurate for the request. Further, at 904, the method 900 may include updating, using the processing device, the request based on the at least one qualifier instruction. Further, at 906, the method 900 may include generating, using the processing device, an updated request based on the updating. Further, the request may include the updated request.

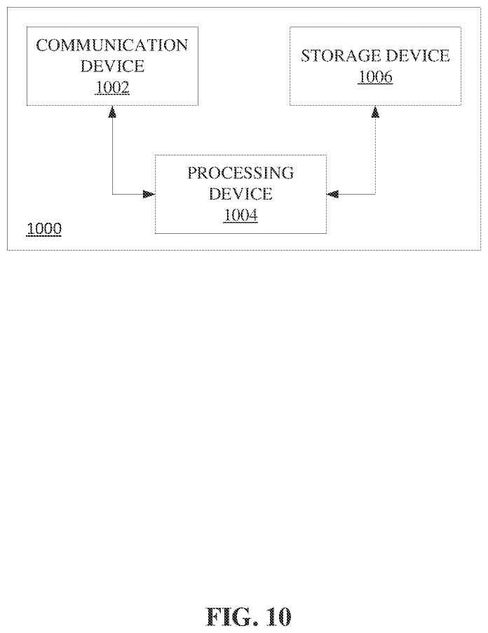

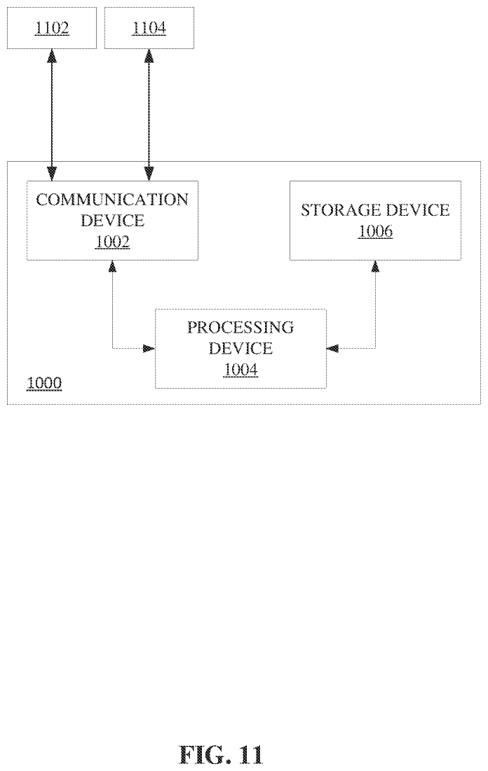

FIG. 10 is a block diagram of a system 1000 for facilitating guiding conversation with at least one large language model, in accordance with some embodiments. Accordingly, the system 1000 may include a communication device 1002 configured for receiving a request from at least one user device 1102 (as shown in FIG. 11) associated with at least one user. Further, the communication device 1002 may be configured for transmitting the request to at least one server 1104 (as shown in FIG. 11). Further, the at least one server 1104 may be configured for hosting the at least one large language model. Further, the communication device 1002 may be configured for receiving a response corresponding to the request from the at least one server 1104. Further, the communication device 1002 may be configured for transmitting the response to the at least one user device 1102 based on a validation indicator.

Further, the system 1000 may include a processing device 1004 communicatively coupled with the communication device 1002. Further, the processing device 1004 may be configured for validating the response based on at least one guideline. Further, the processing device 1004 may be configured for generating the validation indicator associated with the response based on the validating.

Further, the system 1000 may include a storage device 1006 communicatively coupled with the processing device 1004. Further, the storage device 1006 may be configured for retrieving the at least one guideline based on the receiving of the response.

Further, in some embodiments, the processing device 1004 may be configured for comparing the validation indicator with a threshold validation indicator. Further, the processing device 1004 may be configured for determining a violation indication based on the comparing. Further, the violation indication may include one of a positive violation indication indicating violation of the response according to the at least one guideline and a negative violation indication indicating compliance of the response to the at least one guideline. Further, the transmitting of the response to the at least one user device 1102 may be based on the violation indication.

Further, in some embodiments, the validating may include analyzing the response using a machine learning model. Further, the validating may include determining an intent associated with the response based on the analyzing of the response. Further, the validating may include analyzing the intent based on the at least one guideline. Further, the validating may include determining an intent compliance indication associated with the intent based on the analyzing of the intent.

Further, in some embodiments, the intent compliance indication may include a negative intent compliance indication. Further, the negative intent compliance indication represents a violation of the at least one guideline by the response. Further, the processing device 1004 may be configured for generating at least one intent instruction associated with the response based on at least one of the negative intent compliance indication and the at least one guideline. Further, the communication device 1002 may be configured for transmitting the at least one intent instruction to the at least one server 1104. Further, the at least one large language model generates the response based on the at least one intent instruction and the request to avoid violation of the at least one guideline.

Further, in some embodiments, the processing device 1004 may be configured for analyzing the request. Further, the processing device 1004 may be configured for determining a request intent corresponding to the request based on the analyzing of the request. Further, the processing device 1004 may be configured for analyzing the request intent based on the at least one guideline. Further, the processing device 1004 may be configured for determining a request intent compliance indication associated with the request intent based on the analyzing of the request intent. Further, the transmitting of the request may be based on the request intent compliance indication.

Further, in some embodiments, the request intent compliance indication may include a negative request intent compliance indication. Further, the negative request intent compliance indication represents a violation of the at least one guideline by the request. Further, the processing device 1004 may be configured for modifying the request based on at least one of the negative request intent compliance indication and the at least one guideline. Further, the processing device 1004 may be configured for generating a modified request based on the modifying. Further, the request may include the modified request.

Further, in some embodiments, the validating may include analyzing the response using a second machine learning model. Further, the validating may include determining a language compliance indication corresponding to the response based on the analyzing of the response. Further, the language compliance indication represents that the response comprises at least one permitted keyword.

Further, in some embodiments, the language compliance indication may include a negative language compliance indication representing usage of at least one blocked keyword in the response. Further, the processing device 1004 may be configured for generating at least one language instruction associated with the response based on at least one of the negative language compliance indication and the at least one guideline. Further, the communication device 1002 may be configured for transmitting the at least one language instruction to the at least one server 1104. Further, the at least one large language model generates the response based on the at least one language instruction and the request to avoid usage of the at least one blocked keyword in the response.

Further, in some embodiments, the processing device 1004 may be configured for determining at least one request guiding instruction corresponding to the request based on the at least one guideline. Further, the processing device 1004 may be configured for updating the request based on the at least one request guiding instruction. Further, the processing device 1004 may be configured for generating an updated request based on the updating. Further, the request may include the updated request.

Further, in some embodiments, the communication device 1002 may be configured for receiving at least one qualifier instruction associated with the request from the at least one user device 1102. Further, the processing device 1004 may be configured for updating the request based on the at least one qualifier instruction. Further, the processing device 1004 may be configured for generating an updated request based on the updating. Further, the request may include the updated request.

FIG. 11 is a block diagram of the system 1000 for facilitating guiding conversation with at least one large language model, in accordance with some embodiments.

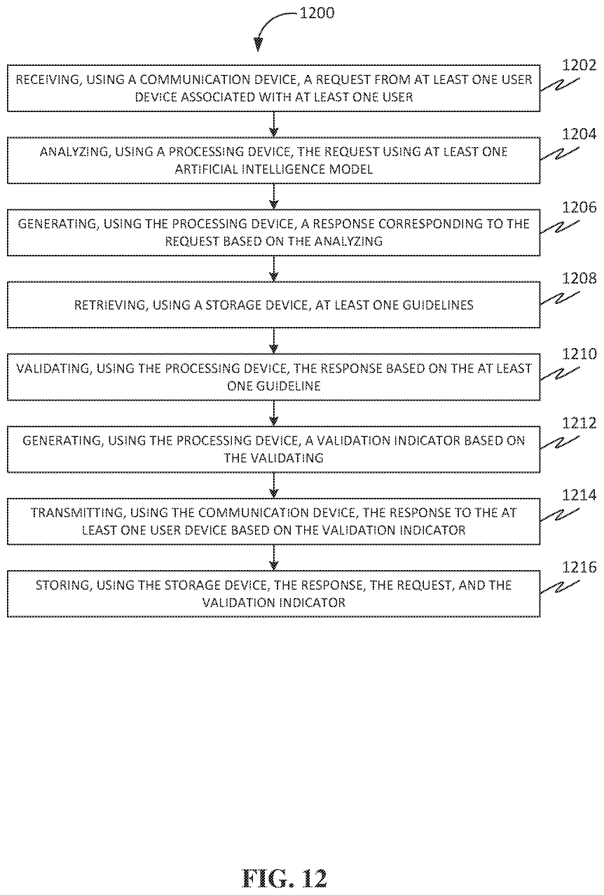

FIG. 12 is a flow chart of a method 1200 for facilitating guiding conversation with artificial intelligence models, in accordance with some embodiments. Accordingly, at 1202, the method 1200 may include receiving, using a communication device, a request from at least one user device associated with at least one user. Further, the request may include a query provided by the at least one user. Further, the request may indicate that the at least one user may want to receive a response using at least one artificial intelligence model. Further, the at least one user device may include a smartphone, a tablet, a laptop, and so on. Further, the at least one user may include an individual, an institution, and an organization.

Further, at 1204, the method 1200 may include analyzing, using a processing device, the request using at least one artificial intelligence model. Further, the at least one artificial intelligence model may include a generative AI model. Further, the generative AI model may include ChatGPT.

Further, at 1206, the method 1200 may include generating, using the processing device, a response corresponding to the request based on the analyzing.

Further, at 1208, the method 1200 may include retrieving, using a storage device, at least one guideline. Further, the at least one guideline may include a rule or protocol that may ensure the intent and language of the response does not violate at least one guideline. Further, the at least one guideline may ensure that the response does not include any blocked keyword.

Further, at 1210, the method 1200 may include validating, using the processing device, the response based on the at least one guideline.

Further, at 1212, the method 1200 may include generating, using the processing device, a validation indicator based on the validating.

Further, at 1214, the method 1200 may include transmitting, using the communication device, the response to the at least one user device based on the validation indicator.

Further, at 1216, the method 1200 may include storing, using the storage device, the response, the request, and the validation indicator.

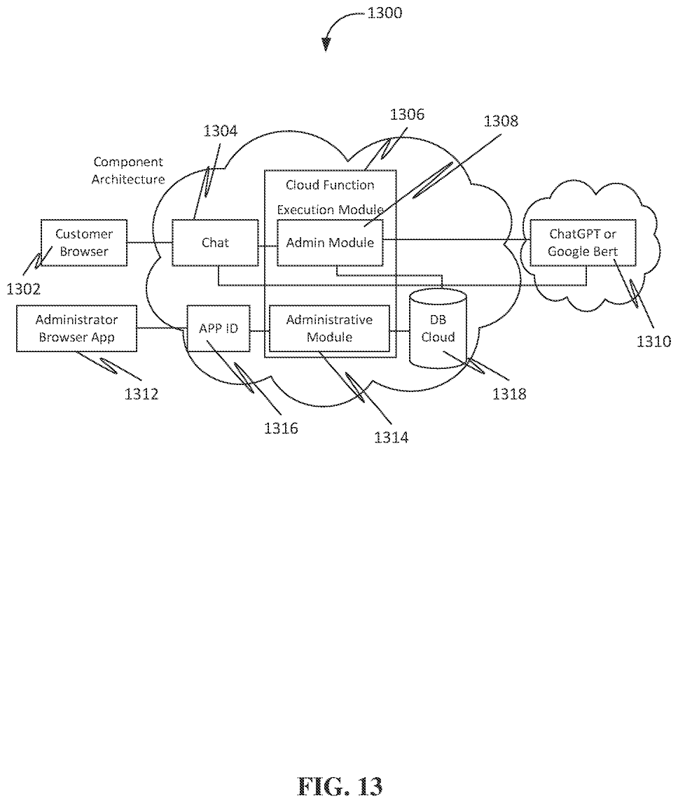

FIG. 13 is a schematic of a system 1300 for facilitating guiding conversation with artificial intelligence models, in accordance with some embodiments. Accordingly, at 1304, the system 1300 may include a customer browser 1302 for allowing a user to chat. Further, the system 1300 may include an execution module 1306. Further, the execution module 1306 may include an admin module 1308 communicatively coupled with at least one large language model 1310 such as ChatGPT or Google™ Bert. Further, the system 1300 may include an administrator browser app 1312. Further, the execution module 1306 may include an administrative module 1314 connected to the administrator browser app 1312 based on an app ID 1316. Further, the system 1300 may include a database cloud 1318 communicatively coupled with the admin module 1308 and the administrative module 1314.

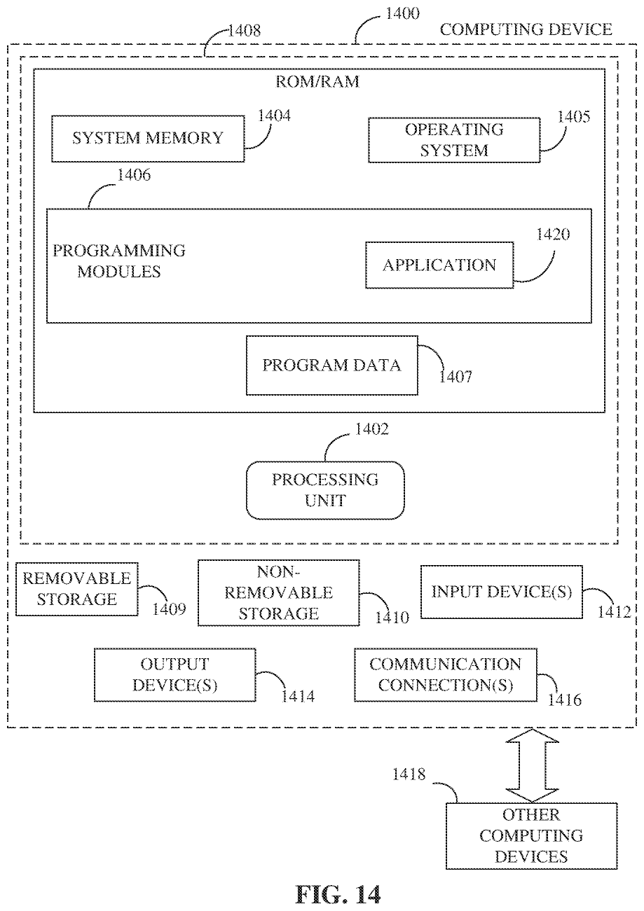

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include image-processing module and machine learning module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable, and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating guiding conversation with at least one large language model, the method comprising:
receiving, using a communication device, a request from at least one user device associated with at least one user;
transmitting, using the communication device, the request to at least one server, wherein the at least one server is configured for hosting the at least one large language model;
receiving, using the communication device, a response corresponding to the request from the at least one server;
retrieving, using a storage device, at least one guideline based on the receiving of the response;
validating, using a processing device, the response based on the at least one guideline;
generating, using the processing device, a validation indicator associated with the response based on the validating; and
transmitting, using the communication device, the response to the at least one user device based on the validation indicator.

2. The method of claim 1 further comprising:
comparing, using the processing device, the validation indicator with a threshold validation indicator; and
determining, using the processing device, a violation indication based on the comparing, wherein the violation indication comprises one of a positive violation indication indicating violation of the response according to the at least one guideline and a negative violation indication indicating compliance of the response to the at least one guideline, wherein the transmitting of the response to the at least one user device is further based on the violation indication.

3. The method of claim 1, wherein the validating comprises:
analyzing the response using a machine learning model;
determining an intent associated with the response based on the analyzing of the response;
analyzing the intent based on the at least one guideline; and
determining an intent compliance indication associated with the intent based on the analyzing of the intent.

4. The method of claim 3, wherein the intent compliance indication comprises a negative intent compliance indication, wherein the negative intent compliance indication represents a violation of the at least one guideline by the response, wherein the method further comprises:
generating, using the processing device, at least one intent instruction associated with the response based on at least one of the negative intent compliance indication and the at least one guideline; and
transmitting, using the communication device, the at least one intent instruction to the at least one server, wherein the at least one large language model generates the response based on the at least one intent instruction and the request to avoid violation of the at least one guideline.

5. The method of claim 1 further comprising:
analyzing, using the processing device, the request;
determining, using the processing device, a request intent corresponding to the request based on the analyzing of the request;
analyzing, using the processing device, the request intent based on the at least one guideline; and
determining, using the processing device, a request intent compliance indication associated with the request intent based on the analyzing of the request intent, wherein the transmitting of the request is further based on the request intent compliance indication.

6. The method of claim 5, wherein the request intent compliance indication comprises a negative request intent compliance indication, wherein the negative request intent compliance indication represents a violation of the at least one guideline by the request, wherein the method further comprises:
modifying, using the processing device, the request based on at least one of the negative request intent compliance indication and the at least one guideline; and
generating, using the processing device, a modified request based on the modifying, wherein the request comprises the modified request.

7. The method of claim 1, wherein the validating comprises:
analyzing the response using a second machine learning model; and
determining a language compliance indication corresponding to the response based on the analyzing of the response, wherein the language compliance indication represents that the response comprises at least one permitted keyword.

8. The method of claim 7, wherein the language compliance indication comprises a negative language compliance indication representing usage of at least one blocked keyword in the response, wherein the method further comprises:
generating, using the processing device, at least one language instruction associated with the response based on at least one of the negative language compliance indication and the at least one guideline; and
transmitting, using the communication device, the at least one language instruction to the at least one server, wherein the at least one large language model generates the response based on the at least one language instruction and the request to avoid usage of the at least one blocked keyword in the response.

9. The method of claim 1 further comprising:
determining, using the processing device, at least one request guiding instruction corresponding to the request based on the at least one guideline;
updating, using the processing device, the request based on the at least one request guiding instruction; and
generating, using the processing device, an updated request based on the updating, wherein the request comprises the updated request.

10. The method of claim 1 further comprising:
receiving, using the communication device, at least one qualifier instruction associated with the request from the at least one user device;
updating, using the processing device, the request based on the at least one qualifier instruction; and
generating, using the processing device, an updated request based on the updating, wherein the request comprises the updated request.

11. A system for facilitating guiding conversation with at least one large language model, the system comprising:
a communication device configured for:
receiving a request from at least one user device associated with at least one user;
transmitting the request to at least one server, wherein the server is configured for hosting the at least one large language model;
receiving a response corresponding to the request from the at least one server; and
transmitting the response to the at least one user device based on a validation indicator;
a processing device communicatively coupled with the communication device, wherein the processing device is configured for:
validating the response based on at least one guideline; and
generating the validation indicator associated with the response based on the validating; and
a storage device communicatively coupled with the processing device, wherein the storage device is configured for retrieving the at least one guideline based on the receiving of the response.

12. The system of claim 11, wherein the processing device is further configured for:
comparing the validation indicator with a threshold validation indicator; and
determining a violation indication based on the comparing, wherein the violation indication comprises one of a positive violation indication indicating violation of the response according to the at least one guideline and a negative violation indication indicating compliance of the response to the at least one guideline, wherein the transmitting of the response to the at least one user device is further based on the violation indication.

13. The system of claim 11, wherein the validating comprises:
analyzing the response using a machine learning model;
determining an intent associated with the response based on the analyzing of the response;
analyzing the intent based on the at least one guideline; and
determining an intent compliance indication associated with the intent based on the analyzing of the intent.

14. The system of claim 13, wherein the intent compliance indication comprises a negative intent compliance indication, wherein the negative intent compliance indication represents a violation of the at least one guideline by the response, wherein the processing device is further configured for generating at least one intent instruction associated with the response based on at least one of the negative intent compliance indication and the at least one guideline, wherein the communication device is further configured for transmitting the at least one intent instruction to the at least one server, wherein the at least one large language model generates the response based on the at least one intent instruction and the request to avoid violation of the at least one guideline.

15. The system of claim 11, wherein the processing device is further configured for:
analyzing the request;
determining a request intent corresponding to the request based on the analyzing of the request;
analyzing the request intent based on the at least one guideline; and
determining a request intent compliance indication associated with the request intent based on the analyzing of the request intent, wherein the transmitting of the request is further based on the request intent compliance indication.

16. The system of claim 15, wherein the request intent compliance indication comprises a negative request intent compliance indication, wherein the negative request intent compliance indication represents a violation of the at least one guideline by the request, wherein the processing device is further configured for:
modifying the request based on at least one of the negative request intent compliance indication and the at least one guideline; and
generating a modified request based on the modifying, wherein the request comprises the modified request.

17. The system of claim 11, wherein the validating comprises:
analyzing the response using a second machine learning model; and
determining a language compliance indication corresponding to the response based on the analyzing of the response, wherein the language compliance indication represents that the response comprises at least one permitted keyword.

18. The system of claim 17, wherein the language compliance indication comprises a negative language compliance indication representing usage of at least one blocked keyword in the response, wherein the processing device is further configured for generating at least one language instruction associated with the response based on at least one of the negative language compliance indication and the at least one guideline, wherein the communication device is further configured for transmitting the at least one language instruction to the at least one server, wherein the at least one large language model generates the response based on the at least one language instruction and the request to avoid usage of the at least one blocked keyword in the response.

19. The system of claim 11, wherein the processing device is further configured for:
determining at least one request guiding instruction corresponding to the request based on the at least one guideline;
updating the request based on the at least one request guiding instruction; and
generating an updated request based on the updating, wherein the request comprises the updated request.

20. The system of claim 11, wherein the communication device is further configured for receiving at least one qualifier instruction associated with the request from the at least one user device, wherein the processing device is further configured for:
updating the request based on the at least one qualifier instruction; and
generating an updated request based on the updating, wherein the request comprises the updated request.
